(19) United States
(12) Patent Application Publication
(10) Pub. No.: US 2012/0028073 A1
(43) Pub. Date: Feb. 2, 2012

(54) PROCESS FOR ELECTROPLATING OF COPPER

(75) Inventors: Yair Ein-Eli, Haifa (IL); Nina Sezin, Haifa (IL); David Starosvetsky, Yokneam Ilit (IL)

(73) Assignee: Technion Research & Development Foundation Ltd., Haifa (IL)

(21) Appl. No.: 13/148,961

(22) PCT Filed: Feb. 11, 2010
(86) PCT No.: PCT/IL2010/000129

§ 371 Date: Oct. 3, 2011

Related U.S. Application Data
(60) Provisional application No. 61/151,874, filed on Feb. 12, 2009.

(51) Int. Cl. B32B 15/01; B32B 15/00; B32B 15/20; C25D 5/34; C25D 3/38

(52) U.S. Cl. 428/642; 205/205; 428/674; 428/641

(57) ABSTRACT

A process for electroplating high adhesion copper layer on a surface of a highly oxidizable metal in an invariable container, and products produced by this process are provided.

### FIELD AND BACKGROUND OF THE INVENTION

The present invention, in some embodiments thereof, relates to material science, and more particularly, but not exclusively, to electroplating of copper on a metal substrate such as used for barrier layer in microelectronic circuits.

In modern electronics and semiconductor industries there is a requirement to lay a thin layer of copper over other substances (copper metallization process), typically titanium, titanium nitride, tantalum, tantalum nitride, tungsten and tungsten nitride, and the like, serving as a barrier film in microelectronics, in order to provide a physical conducting features thereon.

Traditionally, the process involved chemical vapor deposition (CVD) or physical vapor deposition (PVD) of a layer of copper on the barrier film so as to form seeds, or a seeding layer of copper for the next step of copper electroplating. CVD and PVD are cumbersome and expensive techniques which require high vacuum and other pristine conditions, while electroplating is a cheap process performed in solution. However, the layer of electroplated copper would not have the necessary adhesion to the tantalum film without the seeding step.

The progress in miniaturization ultra large scale integration (ULSI) design, achieving size features smaller than 30 nanometers, requires new approaches in copper interconnect (IC) metallization. Traditional metallization process, which includes intermediate CVD/PVD of copper seed layer on barrier film prior to feature-filling by copper electroplating, cannot be effective once feature dimensions are comparable with seed layer thickness.

One option for metallization of such narrow features (less than 30 nanometers), being thoroughly studied in recent years, is to eliminate the step of PVD of the copper seed layer, along with a reduction in barrier film thickness, down to several nanometers. Thus, copper electroplating should be performed eventually directly over the thin barrier film.

A major obstacle of direct copper plating on tantalum-based materials is associated with the passivation oxide film of tantalum pentoxide, Ta₂O₅, developed on the tantalum electrode surface while exposing it to aqueous solutions. This problem exists also for other barrier materials. Furthermore, tantalum oxide surface is characterized by both poor wetting and adhesion of the electrodeposited metals. Therefore, efficient copper plating could be performed on a tantalum surface only with a complete removal of its oxide film. However, it is absolutely necessary that a complete oxide removal process from a thin tantalum film should be conducted without an additional thinning of the tantalum barrier film.

Current approaches to tantalum oxides removal are based on either chemical etching in halide ions (such as fluoride) containing acidic solutions, or anodic polarization in saturated alkaline solutions. Chemical etching in fluoride containing acidic solutions is usually characterized with a relatively high etching rate that can lead to excessive thinning of the tantalum barrier film. The perforation of the tantalum film at certain surface sites cannot be avoided completely in fluoride acid solution's etching, taking into account the inconsistency of wafer surface exhibiting “trenches and ducts” with varying dimensions and aspect ratio, as well as certain irregularities presented in the tantalum film itself. In addition, fluoride acid solution etching does not exclude subsequent re-oxidation of the tantalum surface due to contact with air and/or washing in aqueous media.

Additional problems associated with tantalum surface oxidation are related to the subsequent copper plating process. Since tantalum surface is rapidly re-oxidized by immersion and exposure to an aqueous solution or exposure to the oxygen found in ambient air, copper electrodeposition should be conducted (at least during the initial deposition steps), under specific conditions which would prevent tantalum or copper oxide reformation and growth.

U.S. Pat. No. 7,135,404 teaches a process for producing structures containing metallized features for use in microelectric workpieces, which includes treating a barrier layer to promote the adhesion between the barrier layer and the metallized feature, effected by acid treatment of the barrier layer, an electrolytic treatment of the barrier layer, or deposition of a bonding layer between the barrier layer and metallized feature. Specifically, U.S. Pat. No. 7,135,404 teaches a method for forming a metallized feature on a surface of a microelectronic workpiece, which includes contacting the surface of the barrier layer with an electrolyte solution which contains copper ions; applying electrical power to the barrier layer and an electrode in contact with the electrolyte solution to produce an electrolytically treated surface of the barrier layer without depositing metal onto the barrier layer; and electrochemically forming a metallized feature on the electrolytically-treated surface of the barrier layer.

Additional background art documents include U.S. Pat. Nos. 7,405,157, 7,341,946, 6,531,046, 6,515,368, 6,494,219, 6,472,023, 6,413,864, 6,319,387, 6,300,244, 6,277,263, 6,197,181, 5,891,513, 5,358,907, 5,256,274, 5,164,332, 5,151,168, 5,009,714, 4,975,159, 4,574,095 and 4,110,176.

### SUMMARY OF THE INVENTION

The present invention, in some embodiments thereof, relates to material science, and more particularly, but not exclusively, to electroplating of copper on a metal substrate, such as used for barrier layer in microelectronic circuits, which is characterized by execution of the process in solution without the need for high vacuum conditions, and characterized by affording a copper layer of superior adherence to the metal barrier layer including on surfaces of very fine structural features.

Hence, according to an aspect of some embodiments of the present invention, there is provided a process of electroplating copper on a metal substrate, the process comprising:

(i) applying an optimal cathodic potential to the metal substrate in an electrolyte solution for a first time period, to thereby obtain a reduced form of the metal on a surface of the substrate;

(ii) adding copper ions to the electrolyte solution so as to obtain a concentration of the copper ions in the electrolyte that ranges from 0.001 M to 0.1 M while maintaining the cathodic potential for a second time period, to thereby form copper nucleation on the reduced form of the metal; and

(iii) applying an attenuated deposition potential higher by at least 0.5 V than the optimal cathodic potential for a third time period, thereby electroplating copper on the metal substrate.

In some embodiments, the entire process is performed in an invariable container.

In some embodiments, the process further includes:

(iv) adding copper ions to the electrolyte solution so as to obtain a concentration of the copper ions in the electrolyte higher than 0.05 M and applying the attenuated deposition potential for a fourth time period.

In some embodiments, the concentration of the copper ions is 0.2 M.

In some embodiments, the electrolyte has a pH value greater than 8.5.

In some embodiments, the electrolyte solution includes a copper-complexing agent.

In some embodiments, the copper-complexing agent is selected from the group consisting of K₄P₂O₇, (N(CH₃)₄)₄P₂O₇ and K-EDTA.

In some embodiments, the copper-complexing agent is K₄P₂O₇.

In some embodiments, the concentration of the copper-complexing agent in the electrolyte solution ranges from 0.1 M to 0.5 M.

In some embodiments, the concentration of the copper-complexing agent is 0.3 M.

In some embodiments, the first time period ranges from 10 seconds to 60 seconds.

In some embodiments, the first time period is 30 seconds.

In some embodiments, the copper ions are added in the form of Cu₂P₂O₇ to the electrolyte solution.

In some embodiments, the second time period ranges from 1 second to 10 seconds.

In some embodiments, the second time period ranges from 3 seconds to 5 seconds.

In some embodiments, the attenuated deposition potential is −1.4 V.

In some embodiments, the third time period allows a deposition of a continuous copper film over the substrate metal.

In some embodiments, the fourth time period allows a thickening of the copper film over the substrate metal.

In some embodiments of the process presented herein, the electrolyte solution further includes a surface active agent.

In some embodiments, the surface active agent is selected from the group consisting of 2,5-dimercapto-1,3,4-thiadiazole, 2-mercapto-5-methyl-1,3,4-thiadiazole and a thiol-containing organic compound.

In some embodiments of the process presented herein, the metal is a barrier layer metal selected from the group consisting of tantalum, tantalum nitride, ruthenium, ruthenium nitride, titanium, titanium nitride, platinum, and osmium.

In some embodiments, the barrier layer metal is tantalum and the optimal cathodic potential is −2 V.

According to another aspect of some embodiments of the present invention, there is provided a copper metallized substrate produced by the process presented herein.

In some embodiments, the substrate is selected from the group consisting of a microelectronic circuit (chip), an electrode, a silicon/metal wafer, a doped silicon/metal wafer, a silicon/carbide/metal wafer, a germanium/metal wafer, a gallium/metal wafer, an arsenide/metal wafer, a semiconductor/metal wafer and a doped semiconductor/metal wafer.

In some embodiments, the substrate is characterized by at least 95% adherence of the copper layer to the surface of the substrate.

As used herein the term “about” refers to ±10%.

The terms “comprises”, “comprising”, “includes”, “including”, “having” and their conjugates mean “including but not limited to”. The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, an and the include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Some embodiments of the invention are herein described, by way of example only, with reference to the accompanying drawings and images. With specific reference now to the drawings and images in detail, it is stressed that the particulars shown are by way of example and for purposes of illustrative discussion of embodiments of the invention. In this regard, the description taken with the drawings and images makes apparent to those skilled in the art how embodiments of the invention may be practiced.

In the drawings:

FIGS. 1A-B present comparative plots of potentiodynamic characteristics obtained from tantalum electrode polarized in 5, 10, 25 wt. % KOH solutions at a scan rate of 5 mV/s at 25° C. and over a wide potential range (−2 V to +0.4 V), whereas corrosion potential (E_{CORR}) transients obtained from tantalum electrode at OCP in KOH solutions are presented in the inset (FIG. 1A), and the effect of temperature on the potentiodynamic characteristic of tantalum electrode in 10 wt. % KOH solution having a pH value of 10.2, wherein the E_{CORR} transient obtained from tantalum during OCP exposure is shown in the inset (FIG. 1B);

FIG. 2 presents comparative Niquist plots in frequency range between 10⁴ and 10⁻¹ Hz obtained from tantalum electrode immersed in 10 wt. % KOH at temperatures of 25° C., 40° C. and 60° C. subsequent to OCP exposure for 30 seconds;

FIG. 3 presents comparative impedance Niquist spectra obtained from tantalum electrode immersed in a solution of 10% by weight KOH at 25° C. subsequent to 30 seconds potentiostatic exposure at different applied potentials of OCP, −1.3 V, −1.5 V and −1.7 V, wherein EIS of tantalum at potential of −1.9 V and −2.1 V in the same solution are presented in the inset;

FIG. 4 presents comparative impedance Niquist spectra obtained from tantalum electrode immersed in a solution containing 0.3 M K₄P₂O₇ (100 gram/liter aqueous solution of potassium pyrophosphate having a pH of 10.1) at 25° C. subsequent to 30 seconds potentiostatic exposure at different applied potentials of OCP, −1.3 V and −1.5V, wherein EIS of tantalum in 0.3 M K₄P₂O₇ at potentials of −1.7 V and −1.9 V are presented in the inset;

FIGS. 5A-B are FIB cross sectional micrographs of Si/TaN/Ta interface, wherein FIG. 5A is a micrograph of the initial state of the original wafer prior to potential application and FIG. 5B is a micrograph taken after 2 hours of exposure of the wafer to a potential of −2.0 V;

FIG. 6 presents comparative cathodic polarization characteristics of tantalum electrode subsequent to oxide “removal” by cathodic pretreatment at −2 V, as measured in two copper electroplating solutions, namely 0.03 M Cu²⁺+0.3 M K₄P₂O₇ and 0.2 M Cu²⁺+0.6 M K₄P₂O₇, wherein polarization characteristic of tantalum electrode in the absence of cooper ion (0.3 M K₄P₂O₇ solution) are shown in the inset;

FIG. 7 presents comparative current-time transient curves obtained from tantalum electrode polarized in 0.03 M Cu²⁺+0.3 M K₄P₂O₇ solution (pH 9.3) under applied potentials of −1.0 V, −1.1 V and −1.2 V;

FIGS. 8A-B are SEM micrographs obtained from tantalum surface presenting copper nucleus electrodeposited at −1.1 V (FIG. 8A) and −1.2 V (FIG. 8B) in 0.03 M Cu⁺²+0.3 M K₄P₂O₇ (pH 9.3), whereas the total charge accumulated was 100 mC/cm²;

FIG. 9 presents comparative cathodic potentiodynamic curves obtained at 5 mV/s from polarizing tantalum electrode in 0.03 M Cu²⁺+0.3 M K₄P₂O₇ (pH 9.3) at different DMcT concentrations of 0, 1, 5 and 10 ppm;

FIG. 10 presents comparative current-time transient curves obtained from tantalum electrode polarized in 0.03 M Cu⁺²+0.3 M K₄P₂O₇ containing 3 ppm DMcT (pH 9.3) at different applied potentials;

FIGS. 11A-B are SEM micrographs obtained from tantalum surface showing the nucleation and growth of copper crystallites (accumulated 100 mC charge was recorded), electrodeposited on the surface of cathodically pre-treated (−2 V) tantalum at potentials of −1.1 V (FIG. 11A) and −1.2 V (FIG. 11B) in 0.03 M Cu⁺²+0.3 M K₄P₂O₇ containing 3 ppm DMcT (pH 9.3);

FIGS. 12A-B are SEM micrographs obtained from of tantalum foil surface showing nucleation and growth of copper crystallites electrodeposited after 3 seconds exposure under applied potential of −2.0 V in 0.03 M Cu²⁺+0.3 M K₄P₂O₇ (pH 9.3) without additive (FIG. 12A) and with 3 ppm DMcT (FIG. 12B);

FIGS. 13A-B are front view SEM micrographs of coupon wafer surface covered with continuous copper layer electrodeposited on TaN/Ta barrier film for 500 seconds at −1.2 V in 0.03 M Cu²⁺+0.3 M K₄P₂O₇ solution (first electroplating procedure) without DMcT (FIG. 13A) and with 3 ppm of DMcT (FIG. 13B); and

FIGS. 14A-D present cross section FIB micrographs of Si/TaN/Ta patterned wafers having a copper film of about 100 nm thick, deposited in copper pyrophosphate electrolytes over 500 seconds at a potential of −1.2 V in 0.03 M Cu²⁺+0.3 M K₄P₂O₇ and 3 ppm DMcT (pH 9.3) solution at 25° C. (two magnification ratios, FIGS. 14A-B), and after a second and final electroplating procedure conducted over 100 seconds at −1.0 V in 0.2 M Cu²⁺ (as Cu₂P₂O₇)+0.53 M K₄P₂O₇ solution containing 5 ppm DMcT (pH 8.5) at 25° C. (two magnification ratios, FIGS. 14C-D).

### DESCRIPTION OF EMBODIMENTS OF THE INVENTION

The present invention, in some embodiments thereof, relates to material science, and more particularly, but not exclusively, to electroplating of copper on a metal substrate such as used for barrier layer in microelectronic circuits.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

While conceiving the present invention, the inventors have recognized that the difficulties in metallizing tantalum with copper without compromising adhesion of the copper to the tantalum due to the presence of tantalum oxide during the copper metallization process, one should optimize several parameters of the metallization process at the same time. This non-trivial multi-parameter simultaneous optimization was conceived while aiming at obtaining an optimal tantalum metallization by copper in one electrochemical bath, namely nullifying the need for cumbersome and expensive use of high vacuum (as required by CVD/PVD) and nullifying the need for sample wash/rinse/dry and transfer cycles which expose the barrier metal to reoxidation in ambient air.

While reducing the present invention to practice, the present inventors have surprisingly uncovered that this multi-faceted optimization task, which spans both chemical and physical considerations as well as economical and industrial aspects, can be achieved by applying a novel rational of optimization for each of the parameters of this problem, which include:
(i) reducing tantalum oxide at the lowest possible cathodic polarization potential, namely the most suitable negative potential possible that would still allow controlled deposition of copper (minimal adverse effects such as the evolution of hydrogen bubbles) on the freshly oxide-cleaned tantalum surface while not releasing the “cathodic pressure” on the tantalum (maintaining to apply the cathodic potential well into the initial copper nucleation and seeding deposition stage); and
(ii) creating optimal conditions for controlled copper deposition in the most multiple and smallest-size nucleation sites so as to cover the entire tantalum surface and fill-in very fine structural features in the tantalum layer (sufficiently slow rate and maximization of multiplicity of nucleation sites), without which copper deposition would be too rapid at this cathodic potential and accompanied by hydrogen gas generation, leading to reduced copper layer uniformity and adhesion; and
(iii) maintaining the chemical conditions in the electrolyte that would allow continuous and accelerated copper deposition on the freshly formed copper seed layer thus forming a copper layer at any desired thickness, based on the optimally adherent copper-seed layer.

As used herein, the phrase “anodic process” refers to processes which involve positive charge transfer through electrode/solution interface (from electrode to solution) or opposite transfer of negative charges (electrons, anions). Examples of anodic processes are metal dissolution (Me→Me⁺ⁿ+ne⁻), oxides formation, etc.

As used herein, the phrase “cathodic process” refers to processes which involve negative charge transfer through electrode/solution interface (from electrode to solution) or opposite transfer of positive charges (electrons, anions). Examples of cathodic processes is hydrogen reduction (2H⁺+2e⁻→H₂↑), or oxygen depolarization (O₂+2H₂O+4e⁻→4OH⁻), copper deposition (Cu⁺²+2e⁻→Cu⁰), or oxide reduction.

Electrochemical reactions provide certain electrode potential which is referred to as open circuit potential (OCP), or corrosion potential.

The phrase “cathodic potential”, as used herein, refers to potential that is more negative than OCP, and the shift of electrode potential in the negative direction is referred to as cathodic polarization.

The term “potential”, as used herein, refers to a potential as measured against a standard saturated calomel electrode (SCE), used as a reference electrode.

Copper begins to deposit electrochemically at a slow rate at about −0.5 V, wherein the copper deposition potential value depends, at least in part, on the chemical composition of the electrolyte (pH, Cu⁺² concentration, copper ion complexation/chelation, etc.). Copper undergoes electric deposition at a higher rate when more negative potential values are applied. Hence, in order to control (slow-down the rate of) copper deposition, one can use a moderate negative potential during copper deposition in order to achieve better adhesion of the copper to the substrate. However, if the potential cannot be reduced, as in the present case, since any reduction of the potential, even for an instant, would allow reformation of the barrier metal oxide, the rate at which copper is deposited must be controlled by other means. While reducing the present invention to practice, the inventors used chemical means to achieve controlled copper electroplating, such as working at a low copper ion concentration and minimizing the duration of exposure of this low concentration of copper ions to the high deposition potential.

Furthermore, when copper deposits at such a high cathodic potential, hydrogen evolution adversely affects the copper deposition due to bubbles, extreme pH variations in microscopic locations and other phenomena, resulting in reduced adhesion of the deposited copper to the substrate. Thus, while reducing the present invention to practice, the inventors made the electrolyte solution in which the entire process is taking place alkaline (i.e. basic, at a pH higher than 8.5). This was achieved by using a base like KOH or the use of other electrolytes such as potassium pyrophosphate.

Further-still, it was realized that the rate of copper deposition during the exposure period to high potential can be further reduced by using a specific electrolyte composition that promotes complexation processes between the electrolyte and the copper ions. The inventors harnessed the copper-complexing capability of the electrolyte substance potassium pyrophosphate, thereby using it as a dual-purpose agent which also serves as an alkaline (basic) electrolyte for the entire process.

In addition, the inventors have included specific additives that temporarily block the tantalum surface to nucleation of copper further reduces the size and the rate at which copper nuclei are formed on the tantalum surface. Examples of such an agent include 2,5-dimercapto-1,3,4-thiadiazole and 2-mercapto-5-methyl-1,3,4-thiadiazole, which are used in copper electroplating metallization for other purposes.

These modifications and conditions assure that the deposition of copper on tantalum would be characterized by high copper-tantalum adhesion and the filling of very fine structural features in the oxide-free tantalum with metallic copper.

Hence, according to an aspect of some embodiments of the invention, there is provided a process of electroplating copper on a metal substrate, the process is effected by:

(i) applying an optimal cathodic potential to the metal substrate in an electrolyte solution for a first time period, to thereby obtain a reduced form of the metal on a surface of the substrate;

(ii) adding copper ions to the electrolyte solution so as to arrive at a final concentration of the cooper ions in the electrolyte that ranges from as low as 0.001 M to 0.05 M or higher while maintaining essentially the same cathodic potential for a second time period, to thereby form copper nucleation on the reduced form of the metal; and

(iii) applying an attenuated deposition potential higher by at least 0.5 V than the optimal cathodic potential for a third time period, thereby electroplating copper on the metal substrate.

In the context of the present embodiments, the terms “electroplating”, electrodeposition” and “deposition” are used interchangeably.

The phrase “optimal cathodic potential”, as used herein, refers to a cathodic potential (more negative versus OCP) at which the required cathodic process, namely the reduction of a metal oxide to the metal, is performed most efficiently. As can be seen in the Examples section that follows (Example 1, FIG. 3), the thicker oxide film on the metal surface, the higher the charge-transfer resistance will be, hence the optimal cathodic potential for tantalum is determined by comparing electrochemical impedance spectroscopy (EIS) data, obtained for a tantalum electrode immersed in an alkaline solution subsequent to a short potentiostatic exposure at different applied potentials of OCP.

Therefore, the cathodic potential which leads to a sharp decrease in the charge-transfer resistance, indicative of a substantially complete reduction of tantalum oxide film, is considered as the optimal cathodic potential for tantalum. This procedure can be applied to any metal/metal oxide.

The exposure of the substrate to the optimal cathodic potential is carried out for a time period (the first time period) which is sufficient to reduce essentially all the metal oxide layer on the surface of the substrate which is in contact with the electrolyte. Typically, the first time period extends from 10 seconds to 60 seconds. As found in the case of tantalum, the first time period may extend as little as 30 seconds, however longer time periods can be used.

After the metal oxide layer is essentially removed, the first deposition of copper can take place. According to the present embodiments, the first copper deposition is effected by adding a solution of copper ions directly into the container used for the metal oxide removal procedure, while not interrupting the optimal cathodic potential at any time. The continuous maintenance of the optimal cathodic potential during the addition of copper ions is required in order not to allow the reformation of the oxide on the surface of the substrate at any time.

The copper ion solution is rather dilute with respect to the copper ions in order to allow a slow rate of copper deposition at this high potential relative to the potential at which copper begins to deposit. Hence, according to some embodiments of the present invention, the copper ions are added, e.g. in a form of a solution, so as to arrive at a concentration in the electrolyte that ranges from as low as 0.001 M to 0.05 M or moderately higher Cu⁺² concentration in the entire volume of the electrolyte.

According to some embodiment of the present invention, the solvent used to prepare the solution of copper ions to be added to the electrolyte is essentially identical to the electrolyte solution, thereby assuring that no adverse chemical reactions or by-products will form in the electrolyte during the process.

According to some embodiments, the concentration of copper ions in the electrolyte during the first deposition ranges from 0.01 M to 0.1 M, and according to some embodiments, the concentration of copper ions in the electrolyte during the first deposition is about 0.03 M.

At this relatively low copper ion concentration, copper nucleates and deposits rather slowly, considering the high cathodic potential, hence a uniform seeding layer of copper is thereby formed.

This first copper deposition procedure is performed for a period of time referred to as the second time period, which extends, according to some embodiments, from 1 to 60 seconds, or according to some embodiments, from 1 to 30 seconds or from 3 to 5 seconds. Keeping the copper nucleation procedure relatively short assists in avoiding large and non-uniform formation of copper seeds due to the exposure to high cathodic potential.

Once the first copper deposition procedure is completed, leaving a copper seed layer on the metal surface under condition which essentially ensures proper adhesion of additional copper deposition thereon, the second copper deposition procedure can take place at a higher cathodic potential, referred to herein as an attenuated deposition potential. The attenuated deposition potential can be effected without the risk of reformation of an oxide layer over the surface of the metal since it is now coated with a well adherent copper layer.

Hence, according to some embodiments of the invention, the cathodic polarization is raised to an attenuated deposition potential which is higher by at least 0.5 V than the optimal cathodic potential for a third time period, thereby electroplating copper on the metal substrate at a cathodic potential that is more suitable for low-rate copper deposition. According to some embodiments, the attenuated deposition potential is −1.4 V.

Once the metal has a uniform and well adherent copper layer deposited thereon, the process may continue to thicken the copper layer as required by the intended use of the copper coated substrate. For this third copper deposition procedure, additional copper ions may be introduced to the electrolyte solution to replenish and increase the supply of copper ions for the continuing electrodeposition process. Hence, according to some embodiments of the present invention, the process further includes adding copper ions to the electrolyte solution so as arrive at a concentration of copper ions in the electrolyte that is higher than 0.05 M, while continuing to apply an attenuated deposition potential for a fourth time period.

The concentration of the copper ions and the duration of the fourth time period depend on the desired thickness of copper at the end of the process.

It will be appreciated that the entire process is performed in a single invariable container, without the need to extract the substrate from the electrolyte solution at any point, thereby reducing the risk of oxide or other contaminants or side-reactions with ambient oxygen or any other external entity. However, it should be noted that third copper deposition procedure can also be performed in separated container or bath containing any electrolyte suitable for any intended use, such as particular wafer feature filling etc., since at the third copper deposition procedure the metal is protected from reoxidation by the primary copper seed layer.

It should also be noted that the superior adherence of the copper layer to the barrier film layer, as well as its capacity to fill small and delicate structural features on the substrate's surface, is achieved without the need for thermal treatment (annealing).

As discussed hereinabove, another factor that plagues copper pristine deposition on metal surfaces at relatively high potential involves the evolution of hydrogen gas. It is assumed that microscopic hydrogen bubbles promote adverse side-reaction on the metal surface that lead to reduction of adhesion of the copper to the metal. The use of an alkali electrolyte substantially alleviates such adverse effects.

As demonstrated in the Examples section that follows below, the use of alkaline electrolyte solution reduced the potential of hydrogen depolarization from −0.1 to −0.2 V, typical values of hydrogen depolarization in acidic electrolytes, to values below −0.7 V, namely decreasing the rate of hydrogen depolarization in the optimal cathodic potential.

Therefore, according to embodiments of the present invention, the electrolyte has a pH value that is greater than 8.5. This pH can be effected by using an alkaline electrolyte such as, for a non-limiting example, KOH, potassium pyrophosphate and the likes.

As discussed hereinabove, attenuation of copper deposition rate while exposing the metal surface to a relatively high cathodic potential can be effected by using copper-complexing agents in the electrolyte. Hence, according to some embodiments, the electrolyte solution includes a copper-complexing agent. In the context of the present embodiments, the copper-complexing agent is an organic or inorganic compound which soluble in the electrolyte medium and can effectively form complexes with the copper ions presented in electrolyte.

When complexing agents, such as pyrophosphate and EDTA, are present in the electrolyte solutions, copper ions are present as complex Cu⁺²-ions (such as [Cu(P₂O₇)₂]⁶⁻ in the case of pyrophosphate). In an electrolyte which contains a complexing agent, the initiation of copper deposition can be shift to much more negative potentials, and in the context of the present embodiments, copper deposition can be accomplished at cathodic potential values which are closer to the optimal cathodic potential where the metal oxide is essentially completely removed, and the rate of hydrogen evolution at potentials of copper deposition will be lower.

Hence, exemplary copper-complexing agents include, without limitation, K₄P₂O₇, (N(CH₃)₄)₄P₂O₇, Na/K-EDTA, Na/K-EDDS (S,S′-ethylenediaminedisuccinic acid, a structural isomer of EDTA) and the likes.

Since pyrophosphate (P₂O₇⁻⁴) is also a copper-complexing agent, the complexing agent can be the dissolved electrolyte substance itself, serving as an alkaline electrolyte as well. Hence, according to some embodiments, the copper-complexing agent is K₄P₂O₇.

According to some embodiments, the concentration of the copper-complexing agent in said electrolyte solution ranges from 0.1 M to 0.5 M. According to some embodiments, the concentration of the copper-complexing agent is 0.3 M.

As presented hereinabove, copper ions can be added to the electrolyte for the first, second or third copper deposition procedures, as a solution of dissolved copper ions in the electrolyte medium as a solvent. Thus, according to some embodiments, the copper ions solution includes Cu₂P₂O₇ dissolved in the electrolyte solution, and the electrolyte may include K₄P₂O₇.

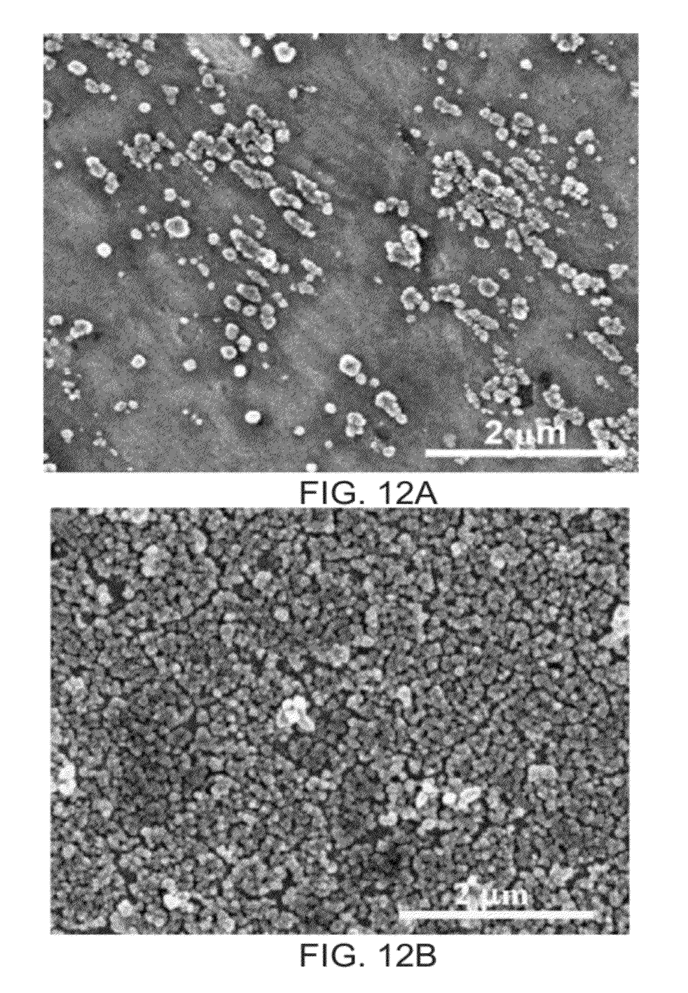

As further discussed hereinabove, in order to control the rate at which copper nucleation is effected, the electrolyte solution may further include a surface active agent. Without being bound by any particular theory, the surface active agent temporarily hinders copper from depositing at or near a position which is already seeded by copper, thereby driving the copper nucleating process towards multiple, small and uniformly spread copper nucleation sites. This effect is demonstrated in the Examples section that follows below, and illustrated clearly in FIG. 12A-B which show the beneficial effect of the presence on a surface active agent.

Non-limiting examples of surface active agent include thiol-containing organic compounds, 2,5-dimercapto-1,3,4-thiadiazole and 2-mercapto-5-methyl-1,3,4-thiadiazole.

The process presented herein can be effected to a number of metals, which include metals used as barrier layer in microelectronic circuit production. Exemplary metals suitable for copper-plating by the process presented herein include tantalum, tantalum nitride, ruthenium, ruthenium nitride, titanium, titanium nitride, platinum, and osmium. In the case of tantalum, which is widely used as a barrier film metal, the optimal cathodic potential was found to be −1.7 V to −2 V.

Hence, according to an aspect of embodiments of the present invention, there is provided a copper metallized substrate produced by the process presented herein.

Exemplary substrates which can be metallized with copper using the process presented herein include, without limitation, microelectronic circuits (chip), electrodes, silicon/metal wafers, any doped silicon/metal wafer wherein the silicon is doped with any dopant, such as antimony, phosphorus, arsenic, boron, aluminum, gallium, selenium and tellurium, silicon-carbide/metal wafers, germanium/metal wafers, gallium/metal wafers, arsenide/metal wafers and any semiconductor/metal wafer. Since the process is performed in a liquid electrolyte that can essentially fill in any structural feature, substrates can be in any form, side and shape, such as coils, plates, tubes, wires, balls, cubes, meshes and the likes.

Once copper-plated using the process presented herein, the treated substrate is characterized by superior adhesion of copper to the surface of the substrate compared to other processes, complete filling of small and fine grain structural features of the substrate before and after annealing, and very low content of contaminants, such as phosphorous, in the final product of the process.

It is expected that during the life of a patent maturing from this application many relevant processes of high adhesion electrochemical copper metallization processes of highly reoxidized surfaces will be developed and the scope of the phrase “high adhesion electrochemical copper metallization process” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions, illustrate some embodiments of the invention in a non limiting fashion.

The aim of the experiments presented below is to determine conditions for seedless copper electrodeposition over a thin tantalum barrier film while removing the surface oxide, and avoiding any thinning in the tantalum barrier film thickness and its re-oxidation during the initial procedures of copper deposition process.

### Materials and Methods

Electrochemical measurements were conducted with a pencil-type tantalum electrode, constructed by mounting a pure tantalum rod (99.99%, 3.5 mm diameter) in an epoxy resin. The electrode was freshly wet-abraded to a 1200 grit finish prior to each experiment.

Commercial patterned silicon wafer having a layer of 20-30 nm of TaN/Ta barrier film prepared by PVD were used in the copper electroplating experiments (Imec, Belgium).

Patterned silicon wafer electrodes (2.5×2.5 cm) were positioned in a polytetrafluoroethylene holder (with a working area of 1 cm²) equipped with an O-ring and with an Ohmic front contact of In—Ga eutectic alloy.

Electrochemical studies were conducted in 500 ml electrochemical cell equipped with a saturated calomel reference electrode (SCE, Luggin capillary) and platinum plate counter electrode. All potential quoted are versus SCE potential.

Copper deposition electrolytes were prepared from potassium pyrophosphate (K₄P₂O₇, Carlo Erba Reagents) and copper pyrophosphate (Cu₂P₂O₇, Alfa Aeasar) dissolved in de-ionized (DI) water (18 MΩ, Millipore). Base solution was 0.34 M (100 gram) K₄P₂O₇.

Both low and high copper ions content in the pyrophosphate electrolytes were used, namely 0.03 M (2 grams per liter) Cu²±, 0.3 M (100 grams per liter) K₄P₂O₇ (pH 9.3), and 0.2 M (12 grams per liter) Cu²±, 0.53 M (175 grams per liter) K₄P₂O₇ (pH 8.5).

Subsequent to the addition of 0.03 M Cu²⁺ as Cu₂P₂O₇ to 0.3 M K₄P₂O₇, the solution's pH was reduced from 10.1 to 9.3, as a result of copper pyrophosphate hydrolysis. The pH of the final copper plating solution (0.53 M K₄P₂O₇+0.2 M Cu₂P₂O₇) was 8.5.

Electroplating was conducted in pyrophosphate solutions additive-free and with the addition of 2,5-dimercapto-1,3,4 thiadiazole, 98% (DMcT, Acros Organics). DMcT is one of the components in PY61-H brightener composition, developed for copper plating baths. Some experiments were conducted also in potassium hydroxide (KOH) solution and potassium pyrophosphate solution.

Potentiostat (PAR 2273) was used in the electrochemical studies and the electrochemical impedance spectroscopy (EIS) measurements.

EIS measurements were conducted with a tantalum pencil-type electrode at 5 mV amplitude sinusoidal signals in the frequencies range between 0.1 Hz and 100 KHz.

Scanning electron microscope (SEM, LEO-982 Geminate FEG-HRSEM) top view and a dual-beam focused ion beam (FIB, FEI Strata 400-S) cross sectional images were used in order to monitor copper nucleation and deposition processes.

The qualitative evaluation of adhesive characteristics of the deposited copper film to the surface of a tantalum foil (5×30×1 mm) was conducted with the use of a bending, a heat-quench and peel-off tests, while copper adhesion characteristics to wafer samples was evaluated by the latter two tests. Procedures of these tests have been described elsewhere [Magagnin, L. et al., Thin Solid Films 434 (2003) 100; and ASTM International Standards B571-97 (2003), Standard practice for qualitative adhesion testing of metallic coatings, paints and coatings, American Society for Testing and Materials (ASTM)].

Tantalum foil (having a deposited copper film) bending test was performed as followed by bending to 180 degrees followed by sample straitening to the initial state. Bent surface zone was thereafter examined by SEM prior and subsequent to the bending test.

Peel-off tests, according to the D-3359-02 ASTM standard, were conducted with adhesive scotch tape with an angle of about 90 degree.

Heat-quench was conducted by thermally heating the samples (deposited tantalum foil or a wafer) in a tube furnace at 300° C. for 2 hours under hydrogen atmosphere.

### Example 1

### Tantalum Oxide “Removal”

Studies of removal of tantalum oxide film from tantalum surface were conducted with a tantalum pencile-type electrode under a cathodic polarization in both KOH and K₄P₂O₇ solutions; the latter serving as the supporting electrolyte for further copper electroplating.

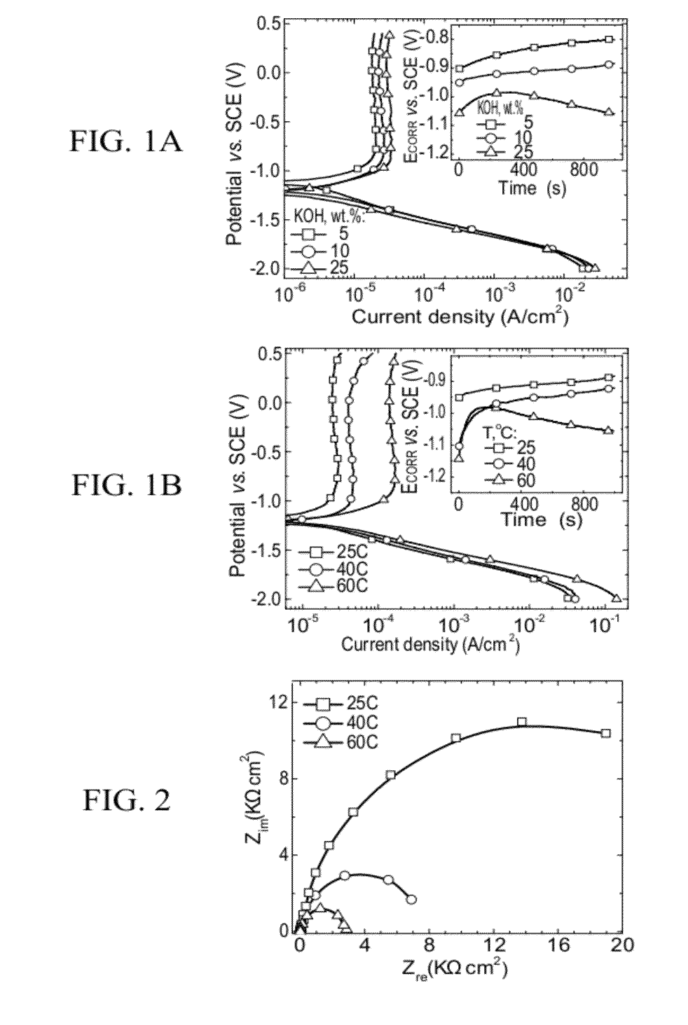

FIG. 1A presents potentiodynamic characteristics (5 mV/s scan rate) obtained from tantalum polarized in 5, 10 and 25 wt. % KOH solutions at 25° C. in a wide potential range (−2 V to +0.4 V), wherein corrosion potential transients obtained from the tantalum electrode exposure at open circuit potential (OCP) conditions in KOH solutions are presented in the inset.

As can be seen in FIG. 1A, the onsets of anodic current in KOH solutions are located in a potential range of −1.1 and −1.2 V, while above these potential values (up to 0.4 V) tantalum electrode remains passive. As can further be seen in FIG. 1A, the anodic current density in the passivity region slightly increases with KOH concentration, indicating a minor reduction in tantalum passivity.

FIG. 1b presents the effect of temperature on the potentiodynamic characteristic of tantalum electrode in 10 wt. % KOH solution having a pH value of 10.2, wherein the E_{CORR} transient obtained from tantalum during OCP exposure is shown in the inset.

As can be seen in FIG. 1B, the anodic current density in the passivity region markedly increases approximately in one order of magnitude once the alkaline electrolyte temperature is increased from 25° C. to 60° C., indicating a significant decrease in tantalum passivity.

The effect of various parameters, such as temperature, solution composition and applied potential, on the state of tantalum electrode interface in alkaline solutions was studied by EIS.

EIS measurements were performed in accordance with Sapra et al. [S. Sapra, H. Li, Z. Wang, I. I. Suni, J. Electrochem. Soc. 152 (2005) B 193], who teaches tantalum oxide removal from tantalum surface in a hydrofluoric acid (HF) solution. In the present case that analysis of the charge-transfer resistance value was used for only a qualitative evaluation of tantalum oxide removal from the electrode surface.

FIG. 2 presents comparative Niquist plots in frequency range between 10⁴ and 10⁻¹ Hz obtained from tantalum electrode immersed in 10 wt. % KOH at temperatures of 25° C., 40° C. and 60° C. subsequent to OCP exposure for 30 seconds.

As can be seen in FIG. 2, the charge-transfer resistance of the tantalum electrode in 10% KOH at OCP significantly decreased with temperature. However, even at 60° C. it remains quite high (about 2.5 KΩcm²), indicating the presence of tantalum oxide film on the electrode surface.

FIG. 3 presents comparative impedance Niquist spectra obtained from tantalum electrode immersed in a solution of 10% by weight KOH at 25° C. subsequent to 30 seconds potentiostatic exposure at different applied potentials of OCP, −1.3 V, −1.5 V and −1.7 V, wherein EIS of tantalum at potential of −1.9 V and −2.1 V in the same solution are presented in the inset.

As can be seen in FIG. 3, the negative shift of the applied potential leads to a decrease in the charge-transfer resistance, indicating a reduction of tantalum oxide film. Notably, the most significant reduction of tantalum oxide occurred at potentials below −1.5 V. The charge-transfer resistance of tantalum electrode was decreased by about four orders of magnitudes by shifting the applied potential from −1.5 V to −2.1 V. The value of charge-transfer resistance obtained at a potential of −2.1 V was substantially reduced. Thus, by application of an appropriate cathodic polarization one can achieve an effective “removal” of tantalum oxide from the tantalum electrode surface, by simply reducing the oxide film into metallic tantalum layer.

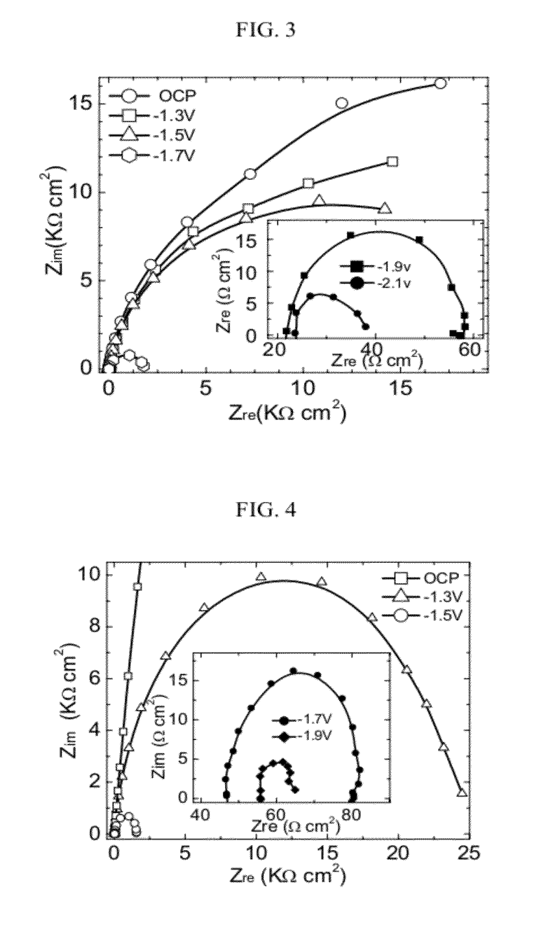

FIG. 4 presents comparative impedance Niquist spectra obtained from tantalum electrode immersed in a solution containing 0.3 M K₄P₂O₇ (100 gram/liter aqueous solution of potassium pyrophosphate having a pH of 10.1) at 25° C. subsequent to 30 seconds potentiostatic exposure at different applied potentials of OCP, −1.3 V and −1.5V, wherein EIS of tantalum in 0.3 M K₄P₂O₇ at potentials of −1.7 V and −1.9 V are presented in the inset.

As can be seen in FIG. 4, similarly to the results obtained in KOH solution, potentiostatic exposure of tantalum electrode in 0.3 M K₄P₂O₇ solution at potentials below −1.5 V also leads to a remarkable decrease in the charge-transfer resistance. This indicates that a “removal” by cathodic reduction of tantalum oxide surface film in this potential range occurs regardless of the type of electrolyte used.

However, it is noted herein that a brief interruption or suspension in the cathodic polarization process results in a rapid development and growth of a fresh tantalum oxide layer.

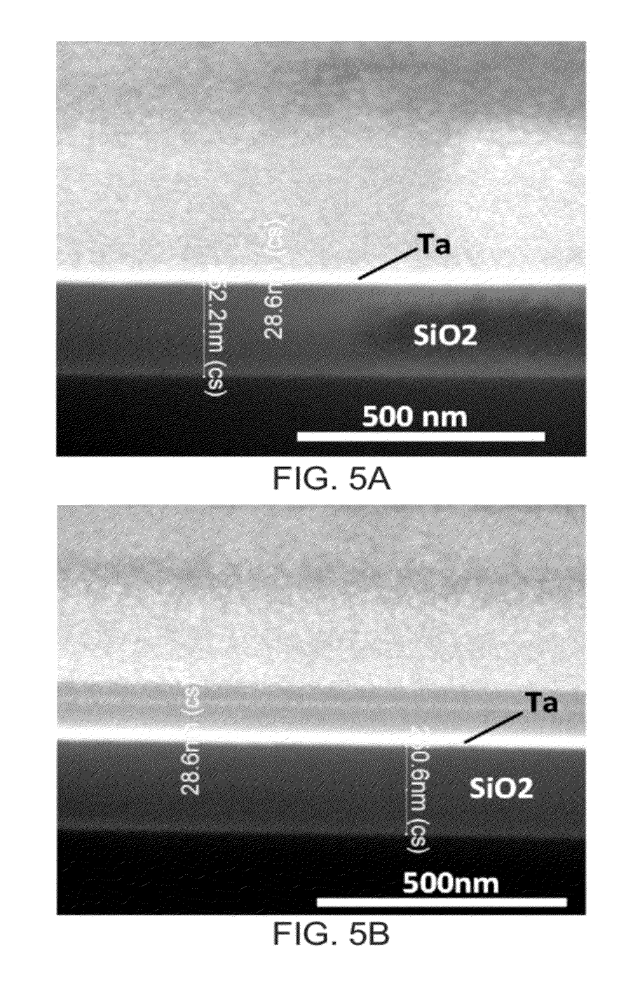

To ensure that the cathodic pretreatment does not reduce the thickness of the tantalum barrier film, wafer samples having a barrier film were exposed for a deliberately extended time of 2 hours, at an applied potential of −2.0 V. The thicknesses of the barrier film prior and subsequent to the long cathodic pretreatment were measured by focused ion beam (FIB) cross sectional view of the Si/TaN/Ta interface, as shown in FIG. 5.

FIGS. 5A-B are FIB cross sectional micrographs of Si/TaN/Ta interface, wherein FIG. 5A is a micrograph of the initial state of the original wafer prior to potential application and FIG. 5B is a micrograph taken after 2 hours of exposure of the wafer to a potential of −2.0 V.

As can be seen in FIGS. 5A-B, no thinning of the tantalum barrier film was detected subsequent to the extended cathodic pretreatment.

One of the conclusions deduced from the experiments presented above, is that tantalum can be cleaned from its oxide by electrolytic treatment, which is most effective when conducted at cathodic polarization of −2 V or lower in an alkaline or otherwise basic electrolyte without corroding metallic tantalum. Another conclusion is that any brief interruption or suspension in the cathodic polarization process results in a rapid development and growth of a fresh tantalum oxide layer which can be removed when cathodic treatment is resumed.

### Example 2

### Copper Electroplating

Copper electroplating over a tantalum electrode surface was conducted in Cu²⁺ containing alkaline pyrophosphate electrolytes prepared from K₄P₂O₇ and Cu₂P₂O₇. Copper ion in alkaline pyrophosphate solutions is being presented as a complex ion, [Cu(P₂O₇)₂]⁶⁻. This specie undergoes a reduction process under cathodic conditions:

[Cu(P₂O₇)₂]⁶⁻+2e⁻→Cu+2[P₂O₇]⁴⁻ (1)

Following the results and conclusions obtained on tantalum oxide “removal” presented in Example 1 hereinabove, copper electrodeposition over a tantalum electrode surface was conducted immediately after tantalum oxides cathodic reduction (removal).

Copper electrodeposition was performed by 30 seconds exposure of the tantalum electrode in 0.3 M K₄P₂O₇ solution (100 gram/liter aqueous solution of potassium pyrophosphate having a pH of 10.1), which served also as the copper bath supporting electrolyte, at a potential of −2 V.

Thus, copper electroplating is being performed in two steps process:

(i) removal of oxide film; and

(ii) subsequent copper electrodeposition.

In the following series of studies, copper deposition (first electroplating procedure) was performed by shifting the applied potential to a higher potential values (greater than −1.4 V) immediately after the cathodic treatment of the tantalum electrode without interruption of the polarization at any point in time.

Small portion (50 ml) of pyrophosphate solution was taken from the 1 liter pyrophosphate solution and poured into a separate container, dissolving 5 grams of Cu₂P₂O₇. Thus, the content of Cu²⁺ ions in the bath was 0.03 M. Cathodic pretreatment was conducted in the remaining supporting electrolyte solution (950 ml), which was stirred by a magnetic stirrer. The solution containing 5 grams of Cu₂P₂O₇ in 50 ml pyrophosphate solution was poured into the electrolyte at the end of the cathodic pretreatment. Copper deposition was initiated by simultaneously applying a potential and adding the 50 ml portion of the solution containing dissolved copper in a pyrophosphate based solution (0.015 M Cu₂P₂O₇+0.3 M K₄P₂O₇) to the bath of the supporting electrolyte (950 ml).

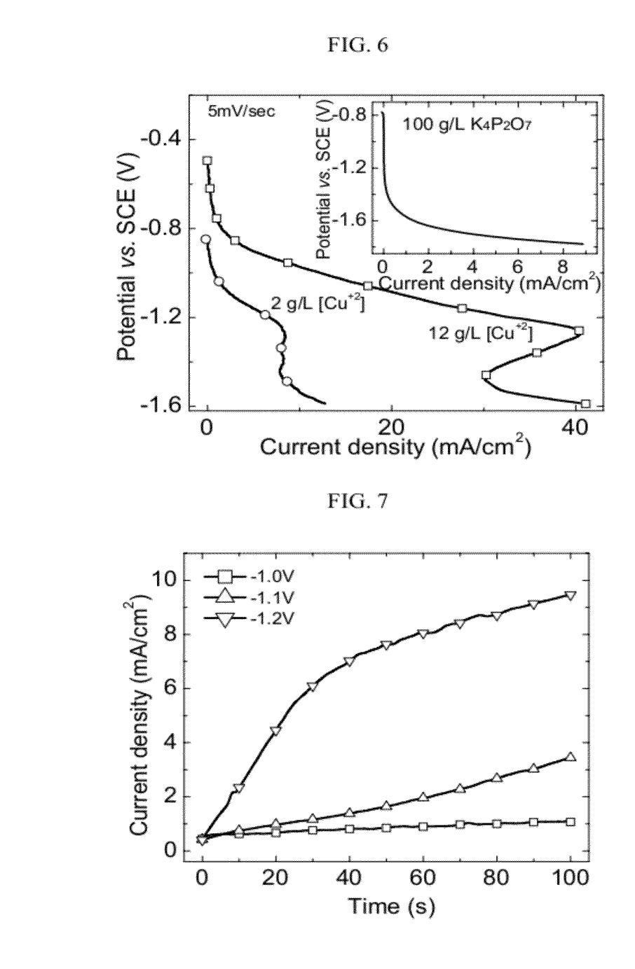

Cathodic behavior of tantalum electrode in copper pyrophosphate solutions is illustrated in FIG. 6. Cathodic polarization characteristics of tantalum electrode were measured in both electroplating solutions containing 0.03 M and 0.2 M Cu²⁺, performed subsequent to a potentiostatic cathodic pretreatment of the tantalum at −2 V for 30 seconds. The cathodic curve obtained from tantalum electrode polarized in the supporting pyrophosphate electrolyte (0.3 M K₄P₂O₇) subsequent to cathodic pretreatment was measured for comparison.

FIG. 6 presents comparative cathodic polarization characteristics of tantalum electrode subsequent to oxide “removal” by cathodic pretreatment at −2 V, as measured in two copper electroplating solutions, namely 0.03 M Cu²⁺+0.3 M K₄P₂O₇ and 0.2 M Cu²⁺+0.6 M K₄P₂O₇, wherein polarization characteristic of tantalum electrode in the absence of cooper ion (0.3 M K₄P₂O₇ solution) are shown in the inset.

As can be seen in FIG. 6, copper electrodeposition in electrolyte containing lower Cu²⁺ concentration (0.03 M) is initiated at more negative potentials (−1.1 vs. −0.8 V detected for the high copper ion solution) and is characterized with a lower current density values compared to copper deposition in electrolyte containing higher Cu²⁺ content (0.2 M). In a solution containing 0.03 M Cu²⁺ the increase in cathodic current density was observed by negative shift of the applied potential down to −1.25 V. Cathodic current density remained practically unaffected (about 8 mA/cm²) in a wide potential range below −1.25 V (between −1.25 and −1.5 V). Maximum cathodic current density value obtained in electrolyte containing 0.2 M Cu²⁺ was 5-fold higher than the value recorded in electrolyte containing 0.03 M Cu²⁺ (40 mA/cm²). Increase in the cathodic current density displayed in both curves at potentials below −1.5 V is associated with acceleration of hydrogen evolution. Cathodic current density values measured potentiodynamically in 0.3 M K₄P₂O₇ solution (see inset of FIG. 6) were significantly smaller compared with values obtained in Cu⁺² containing electrolytes.

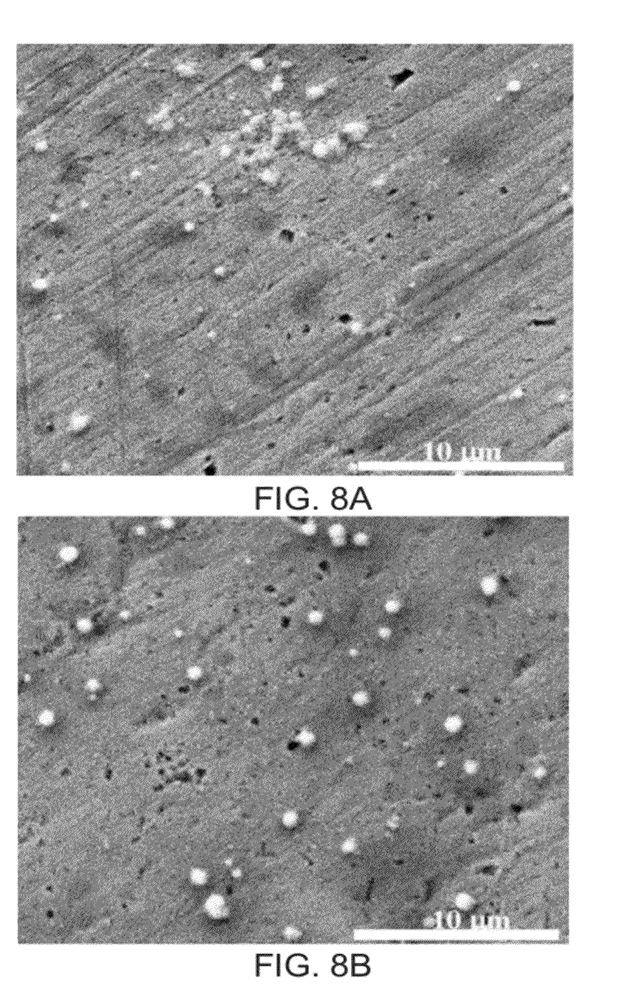

Features of copper deposition on tantalum surface (foil 0.25 mm thickness, pre-polished to 1200 grid finish) in 0.03 M Cu²⁺+0.3 M K₄P₂O₇ electrolyte under the application of different potentials are shown in FIG. 7 and FIG. 8. The required potential was applied subsequent to 30 seconds of pre-exposure at a potential of −2 V. Current-time profiles, presented in FIG. 7, evaluate nucleation and growth of copper on tantalum surface under applied potentials of −1.0, −1.1 and −1.2 V.

FIG. 7 presents comparative current-time transient curves obtained from tantalum electrode polarized in 0.03 M Cu²⁺+0.3 M K₄P₂O₇ solution (pH 9.3) under applied potentials of −1.0 V, −1.1 V and −1.2 V.

As can be seen in FIG. 7, the cathodic current density gradually increased during polarization in all applied potentials, indicating increase in copper deposition rate. Copper deposition rate is pronouncedly increased by a negative shift in the applied potential to −1.2 V, as the cathodic current density is significantly increased at this potential.

These results are in agreement with SEM observation obtained from tantalum surface subsequent to copper deposition at −1.1 and −1.2 V, presented in FIG. 8. Copper deposition under each of these potentials was terminated once a total charge of 100 mC was accumulated.

FIGS. 8A-B are SEM micrographs obtained from tantalum surface presenting copper nucleus electrodeposited at −1.1 V (FIG. 8A) and −1.2 V (FIG. 8B) in 0.03 M Cu⁺²+0.3 M K₄P₂O₇ (pH 9.3), whereas the total charge accumulated was 100 mC/cm².

As can be seen in FIGS. 8A-B, size inconsistency, separation and irregular shape of copper crystallites distributed over tantalum surface is observed in the −1.1 V sample, while the number of nucleated crystallites increases by negatively shifting the applied potential to −1.2 V, in agreement with the electrochemical studies, presented in FIG. 7.

### Example 3

### Copper Electroplating with Dimercaptothiadiazole

In order to achieve a conformal copper deposition over TaN/Ta barrier surface the following studies were conducted with copper pyrophosphate electrolytes having dimercaptothiadiazole (DMcT) as an additive. It is known from copper electroplating onto Pt electrodes that DMcT/copper pyrophosphate electrolyte system involves two additive species, which are in dynamic equilibrium, namely DMcT monomer and DMcT dimmer, and the monomer species form a complex compound with copper-ions. In such case, copper electrodeposition on Pt is accelerated, presumably due to assistance in nucleation of nodule copper crystallites randomly distributed over the surface. Unlike DMcT monomers, dimmer species hinder copper deposition rate on Pt by blocking nucleation surface sites. This dual decelerating/accelerating behavior of DMcT on Pt results eventually in enhanced leveling of copper deposition from pyrophosphate electrolytic bath.

The present experiment describes the use of DMcT in copper pyrophosphate electrolytic bath while tantalum serves as the electroplated electrode.

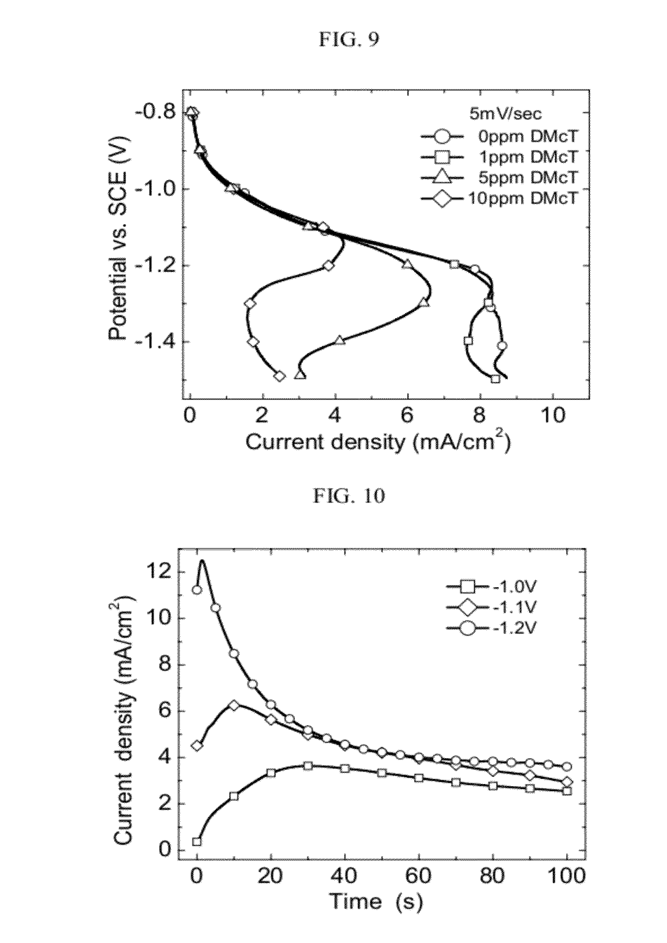

FIG. 9 presents comparative cathodic potentiodynamic curves obtained at 5 mV/s from polarizing tantalum electrode in 0.03 M Cu²⁺+0.3 M K₄P₂O₇ (pH 9.3) at different DMcT concentrations of 0, 1, 5 and 10 ppm.

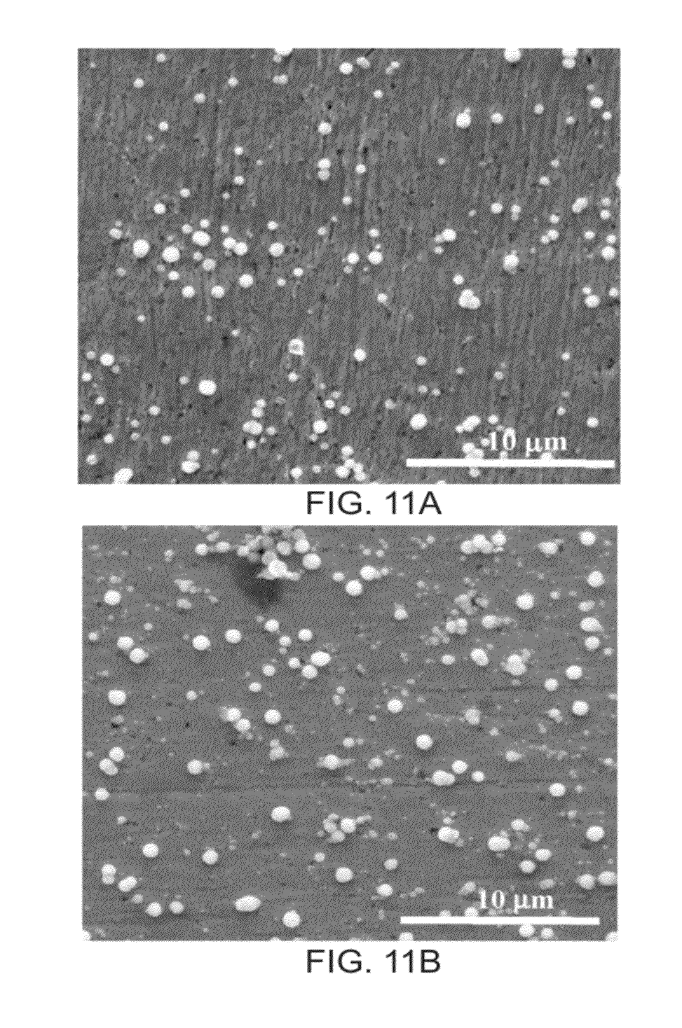

As can be seen in FIG. 9, the maximum value of cathodic current density, associated with copper cathodic reduction rate, is significantly decreased with increase in DMcT concentration. Further studies of copper electroplating solutions containing only 3-5 ppm DMcT were performed, since at this intermediate concentration the acceleration-inhibition effect of DMcT is well established. The effect of potential on copper nucleation and growth in a solution containing 3 ppm DMcT and copper ions-pyrophosphate system (0.03 M Cu²⁺+0.3 M K₄P₂₀₇) is demonstrated by the current transient curves measured at different applied potentials (FIG. 10) and SEM images obtained from copper deposition on a cathodically (−2 V) pre-treated tantalum surface subsequent to a short potentiostatic exposure (passed charge 100 mC) at potentials of −1, −1.1 and −1.2 V (FIGS. 11A-B).

FIG. 10 presents comparative current-time transient curves obtained from tantalum electrode polarized in 0.03 M Cu⁺²+0.3 M K₄P₂O₇ containing 3 ppm DMcT (pH 9.3) at different applied potentials.

As can be seen in FIG. 10, the current transient shape obtained from a potentiostatic exposure in the presence of 3 ppm DMcT is completely different from the one obtained in an additive-free solution (see, FIG. 7). Cathodic current density, related to copper deposition rate, rapidly reached its maximum immediately after potential application and gradually decreased during further exposure. As the applied potential was more negative the current peak was higher and appeared earlier. It is reasonable to suggest that DMcT addition markedly increases copper nucleus formation rate, saturating all possible nucleation sites at the tantalum electrode surface during the initial stages of copper deposition.

FIGS. 11A-B are SEM micrographs obtained from tantalum surface showing the nucleation and growth of copper crystallites (accumulated 100 mC charge was recorded), electrodeposited on the surface of cathodically pre-treated (−2 V) tantalum at potentials of −1.1 V (FIG. 11A) and −1.2 V (FIG. 11B) in 0.03 M Cu⁺²+0.3 M K₄P₂O₇ containing 3 ppm DMcT (pH 9.3).

As can be seen in FIGS. 11 A-B, the presence of DMcT has a remarkable influence, whereas copper crystallites density nucleated and developed under both applied potential of −1.1 and −1.2 V is markedly higher, compared with copper depositions obtained at the same potentials in DMcT-free solution (see, FIG. 8). However, it should be noted that despite this improvement, copper nucleation initiated by the addition of copper containing pyrophosphate solution subsequent to cathodic pretreatment at −2.0 V and positive shift of the applied potential cannot be considered as most suitable one for a conformal filling of sub-micron trenches and ducts since the dimensions of nucleated copper crystals are larger than μm, and density of nucleus remained quite small since the gap between them is higher than a few microns.

In the following experiments, copper nucleation was initiated by adding a portion of a copper pyrophosphate (Cu₂P₂O₇) solution into the supporting electrolyte (0.3M K₄P₂O₇) at the end of the cathodic pretreatment (without interrupting potentiostatic exposure at −2 V) and further exposure for 3-5 seconds under −2 V in Cu²⁺ containing electrolyte.

FIGS. 12A-B are SEM micrographs obtained from of tantalum foil surface showing nucleation and growth of copper crystallites electrodeposited after 3 seconds exposure under applied potential of −2.0 V in 0.03 M Cu²⁺+0.3 M K₄P₂O₇ (pH 9.3) without additive (FIG. 12A) and with 3 ppm DMcT (FIG. 12B).

As can see in FIGS. 12A-B, even after 3 seconds exposure at −2.0 V in the copper pyrophosphate electrolyte with DMcT, the surface of tantalum foil was completely covered with fine copper crystals, while in the absence of DMcT, the density of copper nucleus is markedly lower while the size of the crystals is higher.

### Example 4

### Copper Electroplating on a Commercial Silicon Wafer

Further study of copper deposition on tantalum surface was conducted with commercial patterned silicon wafers having 20-30 nanometer thick TaN/Ta barrier film applied thereon. Identical copper pyrophosphate solution (0.03 M Cu²⁺+0.3 M K₄P₂O₇ and 3 ppm DMcT) and a similar procedure of copper deposition presented in Example 3 were applied, namely:
(i) Tantalum activation procedure which includes a cathodic reduction of tantalum oxide via exposure to a supporting electrolyte, consisting of 0.3 M K₄P₂O₇ solution at potential of −2 V for 30 seconds;
(ii) Nucleation/seeding procedure which includes injection of 0.03 M Cu²⁺ (from a solution of Cu₂P₂O₇) into the supporting electrolyte (0.3 M K₄P₂O₇) without polarization interruption and further exposure for 3-5 s at a potential of −2 V constitutes the first plating stage;
(iii) Second plating procedure which includes potential shift to values above −1.4 V and exposing the seeded electrode surface at this potential for a time length capable of obtaining a continuous copper film over the wafer surface; and
(iv) Final plating procedure wherein a third electroplating stage is conducted in electrolyte bath containing 0.2 M Cu²⁺ and 0.53 M K₄P₂O₇, which is performed in order to accelerate copper deposition.

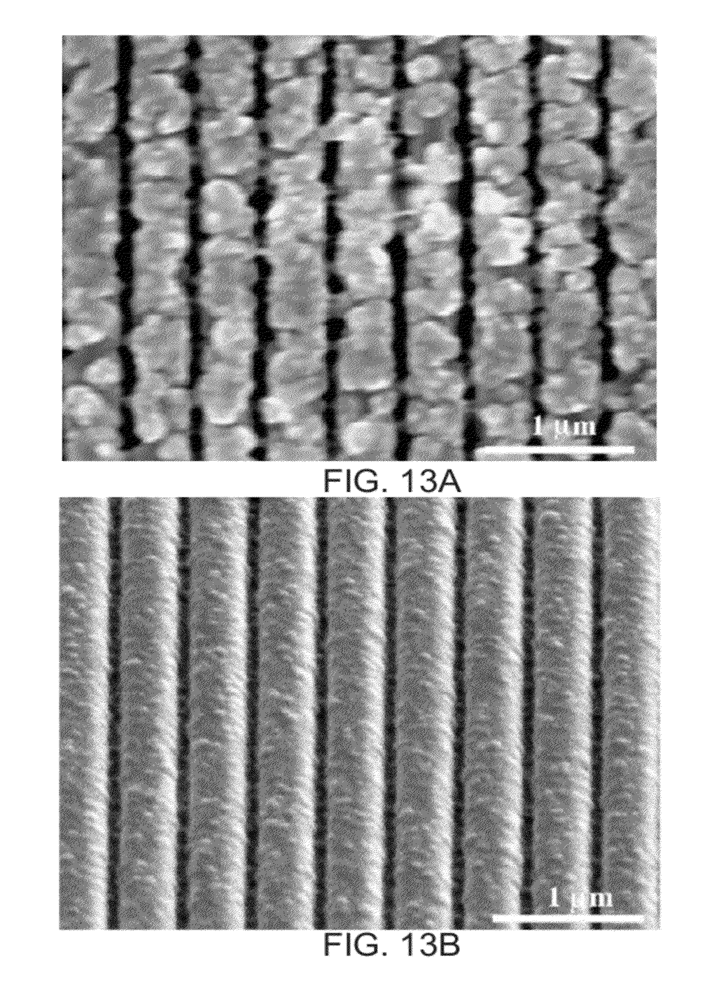

FIGS. 13A-B are front view SEM micrographs of coupon wafer surface covered with continuous copper layer electrodeposited on TaN/Ta barrier film for 500 seconds at −1.2 V in 0.03 M Cu²⁺+0.3 M K₄P₂O₇ solution (first electroplating procedure) without DMcT (FIG. 13A) and with 3 ppm of DMcT (FIG. 13B).

As can be seen in FIGS. 13A-B, copper deposition over a coupon wafer surface, obtained in pyrophosphate solution in the absence of DMcT, is not uniform and is characterized with the formation of large crystals (FIG. 13A), while in the presence of 3 ppm of DMcT a uniform copper deposition was obtained over the whole wafer coupon surface including centered and peripheral zones (FIG. 13B).

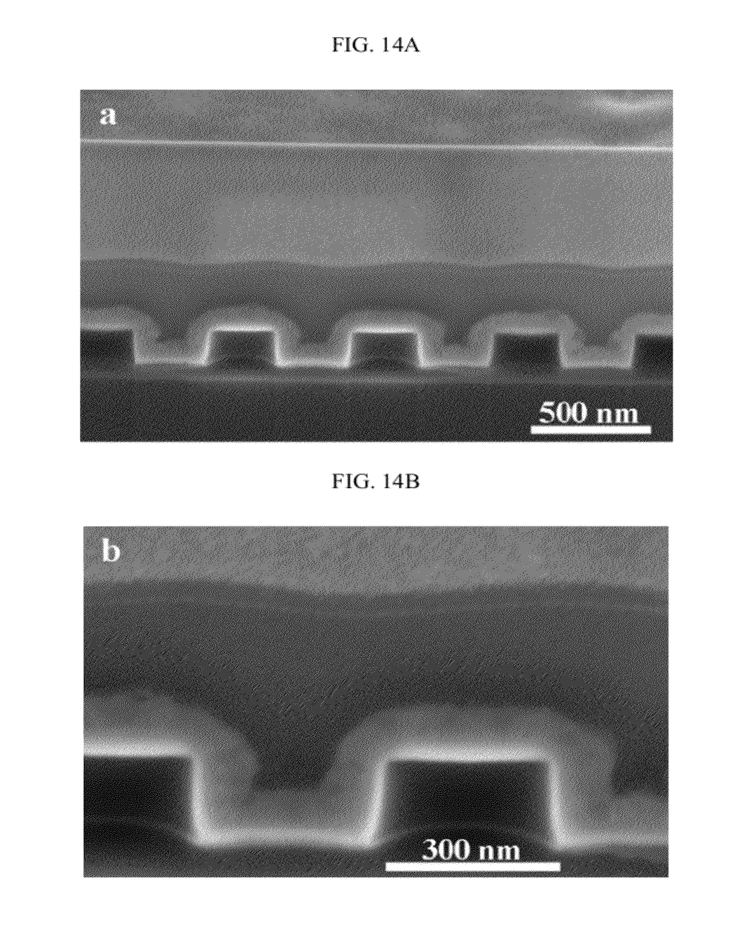

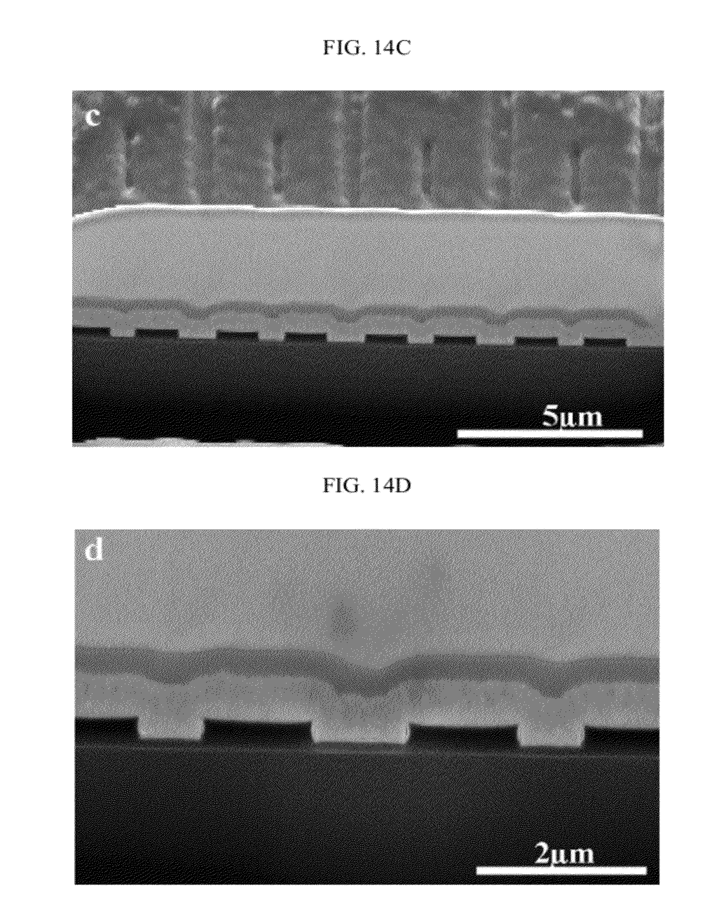

FIB cross sectional view of Si/TaN/Ta patterned wafer surface having a copper layer deposited in DMcT containing copper pyrophosphate solution is shown in FIGS. 14A-D.

FIGS. 14A-D present cross section FIB micrographs of Si/TaN/Ta patterned wafers having a copper film of about 100 nm thick, deposited in copper pyrophosphate electrolytes over 500 seconds at a potential of −1.2 V in 0.03 M Cu²⁺+0.3 M K₄P₂O₇ and 3 ppm DMcT (pH 9.3) solution at 25° C. (two magnification ratios, FIGS. 14A-B), and after a second and final electroplating procedure conducted over 100 seconds at −1.0 V in 0.2 M Cu²⁺ (as Cu₂P₂O₇)+0.53 M K₄P₂O₇ solution containing 5 ppm DMcT (pH 8.5) at 25° C. (two magnification ratios, FIGS. 14C-D).

As can be seen in FIGS. 14A-D, filling of small features in the pyrophosphate solution can be described as a conformal coating process, and the thickness of the deposited copper layer after the final electroplating stage was 450 nm.

The results indicate that the best adhesion of copper to the tantalum electrode surface was obtained when copper nucleation (first plating procedure) was conducted for 3-5 seconds under the applied potential of −2.0 V in pyrophosphate electrolyte containing 0.03 M Cu²⁺ (0.3 M K₄P₂O_{7+0.015} M Cu₂P₂O₇, pH 9.3) and 3 ppm DMcT. Copper film deposited on the surface of a patterned wafer was characterized with a very good adhesion to the thin TaN/Ta barrier film. As was noted above, the adhesion of the deposited copper film to tantalum surfaces (foil and wafer) was qualitatively evaluated by bending (only with tantalum foil), heat-quench and peel-off tests. No exfoliations of copper film from the tantalum surface were observed subsequent to the application of the test methods, indicating a good adhesion between the deposited copper film and the tantalum surfaces.

### Example 5

### Adhesion Tests for Copper on Tantalum

A flat featureless silicon wafer coated with a barrier film of tantalum was copper plated according to the procedure presented in Example 4 hereinabove.

The copper plated wafer was prepared and tested for copper layer adhesion by applying and removing 3M 250 adhesion tape, according to the D-3359-02 ASTM standard test. All plates were photographed with a microscope camera following the adhesion test, and the percentage of the surface which peeled off was calculated.

The results indicated no detectable peeling of the copper layer from tantalum, namely 100% adherence results.

A flat featureless tantalum foil was copper plated according to the procedure presented in Example 4 hereinabove.

The copper-plated foil was bent and creased without any effect on the copper plated layer.

### Example 6

### Summary of the Obtained Results

The results described in Examples 1-4 hereinabove demonstrate an alternative approach for direct in-situ copper electroplating on tantalum surface, being initially covered in pristine passive tantalum oxide layer. The process described in this study involves the use of a single bath for both the stage of tantalum oxide passivating layer removal and copper electroplating. The process may also be applied to other passivated metals and alloys such as ruthenium and ruthenium/tantalum, being currently considered as barrier films for future integrated systems, as well as for other metals such as titanium, titanium nitride, tungsten and tungsten nitride, silver, tin, lead, cadmium, platinum, palladium, iridium, chromium, cobalt, zinc, gold, and alloys thereof.

The following is deduced from the obtained data:

Copper electrodeposition over a thin TaN/Ta barrier can be performed in a two-step process which includes activation of TaN/Ta barrier by a cathodic reduction of tantalum oxide (oxide “removal” procedure), subsequently followed by copper electroplating which is performed in the same electrochemical bath. The tantalum oxide reduction (“removal”) is performed in 0.3 M K₄P₂O₇ solution under the application of a potential of −2 V for 30 seconds. At this potential, tantalum oxide is being reduced to metallic tantalum.

Copper plating is initiated at a potential of −2 V by injecting low copper content Cu₂P₂O₇ solution, (0.03 M Cu²⁺) and 3 ppm DMcT, into the supporting K₄P₂O₇ electrolyte, followed by 3-5 seconds exposure in this solution. It was established in this work that DMcT additive improves copper nucleation and growth on tantalum surface, providing a conformal features filling.

Supplementary copper plating is continued by shifting the applied potential to −1.2 V in the same electrolytic bath, while the final plating process can be performed in high copper ion content pyrophosphate solution.

Copper layer deposited is characterized with an excellent adhesion to the tantalum surface.

The copper-metallized wafer features in the study presented herein are well-filled with copper using pyrophosphate chemistry. The organic additives enabled a rapid bottom-up fill, allowing a defect-free filling of narrow features.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A process of electroplating copper on a metal substrate, the process comprising:
(i) applying an optimal cathodic potential to the metal substrate in an electrolyte solution for a first time period, to thereby obtain a reduced form of said metal on a surface of the substrate;
(ii) contacting said electrolyte solution with copper ions so as to obtain a concentration of said copper ions in said electrolyte that ranges from 0.001 M to 0.1 M while maintaining said cathodic potential for a second time period, to thereby form copper nucleation on said reduced form of said metal; and
(iii) applying an attenuated deposition potential higher by at least 0.5 V than said optimal cathodic potential for a third time period, thereby electroplating copper on the metal substrate.

2. The process of claim 1, being performed in an invariable container.

3. The process of claim 1, further comprising:
(iv) contacting said electrolyte solution with copper ions so as obtain a concentration of said copper ions in said electrolyte higher than 0.05 M and applying said attenuated deposition potential for a fourth time period.

4. The process of claim 3, wherein said concentration of said copper ions is 0.2 M.

5. The process of claim 1, wherein said electrolyte has a pH value greater than 8.5.

6. The process of claim 5, wherein said electrolyte solution comprises a copper-complexing agent.

7. The process of claim 6, wherein said copper-complexing agent is selected from the group consisting of K₄P₂O₇, (N(CH₃)₄)₄P₂O₇ and K-EDTA.

8. The process of claim 7, wherein said copper-complexing agent is K₄P₂O₇.

9. The process of claim 6, wherein a concentration of said copper-complexing agent in said electrolyte solution ranges from 0.1 M to 0.5 M.

10. The process of claim 8, wherein a concentration of said copper-complexing agent is 0.3 M.

11. The process of claim 1, wherein said first time period ranges from 10 seconds to 60 seconds.

12. The process of claim 11, wherein said first time period is 30 seconds.

13. The process of claim 8, wherein contacting said electrolyte with copper ions comprises adding Cu₂P₂O₇ to said electrolyte solution.

14. The process of claim 1, wherein said second time period ranges from 1 second to 10 seconds.

15. The process of claim 1, wherein said second time period ranges from 3 seconds to 5 seconds.

16. The process of claim 1, wherein said attenuated deposition potential is −1.4 V.

17. The process of claim 1, wherein said third time period allows a deposition of a continuous copper film over the substrate metal.

18. The process of claim 3, wherein said fourth time period allows a thickening of said copper film over the substrate metal.

19. The process of claim 1, wherein said electrolyte solution further comprises a surface active agent.

20. The process of claim 19, wherein said surface active agent is selected from the group consisting of 2,5-dimercapto-1,3,4-thiadiazole, 2-mercapto-5-methyl-1,3,4-thiadiazole and a thiol-containing organic compound.

21. The process of claim 1, wherein said metal is a barrier layer metal selected from the group consisting of tantalum, tantalum nitride, ruthenium, ruthenium nitride, titanium, titanium nitride, platinum, and osmium.

22. The process of claim 21, wherein said barrier layer metal is tantalum.

23. The process of claim 22, wherein said optimal cathodic potential is −2 V.

24. A copper metallized substrate produced by the process of claim 1.

25. The substrate of claim 24, selected from the group consisting of a microelectronic circuit (chip), an electrode, a silicon/metal wafer, a doped silicon/metal wafer, a silicon/carbide/metal wafer, a germanium/metal wafer, a gallium/metal wafer, an arsenide/metal wafer, a semiconductor/metal wafer and a doped semiconductor/metal wafer.

26. The substrate of claim 24, characterized by at least 95% adherence of a copper layer to a surface of the substrate.
